(19) United States
(12) Patent Application Publication
(10) Pub. No.: US 2018/0125280 A1
(43) Pub. Date: May 10, 2018

(54) A FOOD PREPARATION APPLIANCE

(71) Applicant: ARCELIK ANONIM SIRKETI, Istanbul (TR)

(72) Inventors: Onur YAMAN, Istanbul (TR); Sefa HAZIR, Istanbul (TR); Ersin DONMEZ, Istanbul (TR)

(21) Appl. No.: 15/577,745

(22) PCT Filed: Jun. 28, 2016
(86) PCT No.: PCT/EP2016/064910

§ 371 Date: Nov. 28, 2017

(30) Foreign Application Priority Data
Jul. 7, 2015 (TR) A 2015/08407

(51) Int. Cl. A47J 27/00; H05B 6/06; H05B 6/12

(52) U.S. Cl. CPC A47J 27/004; H05B 2213/06; H05B 6/1245; H05B 6/065

(57) ABSTRACT

The present invention relates to a food preparation appliance, suitable to be used on an induction heating cooker with one or more than induction coil, comprising a body wherein foods are placed for food preparation operations like cooking, cutting and mixing; a cover mounted over the body; one or more than one receiver coil that is disposed on the base of the body and that receives energy from the coils on the induction heating cooker; one or more than one foot disposed on the base of the body, and a control unit that provides the controlling of parameters such as cooking temperature, cooking time, mixing speed, etc.

The present invention relates to a food preparation appliance that is operated wirelessly on an induction heating cooker and that is energized from its base.

The food preparation appliances, that are operated on the induction heating cooker with the principle of wireless power transfer, provide savings in time for the preparation of nutriments such as food, beverages, etc. Such kitchen appliances comprise sensors detecting parameters such as temperature, time, etc. and a control unit that controls the operation of all the electronic components. Low level electrical power is required for energizing the control unit. This electrical power is supplied from the induction coil in the induction heating cooker by means of a receiver coil integrated with the base of the food preparation appliance. The receiver coil energizes the control unit by partially receiving energy from the induction coil. The induction heating cookers have various cooking levels and the cooker transfers energy to the appliance according to the cooking level selected by the user. However, the energy between the receiver coil and the induction coil does not change in proportion to the energy level adjusted according to the cooking level and a problem in terms of voltage may occur. Therefore, malfunctions may arise in the induction heating cooker or the food preparation appliance. In the state of the art, components such as transformers or capacitors are used in order to keep constant the voltage between the receiver coil and the induction coil. However, since different voltages may occur in different induction heating cookers, these components do not provide the same benefit in all cases.

In the state of the art International Patent Application No. WO2013098227, a wireless kitchen appliance is disclosed, suitable to be operated on an induction heating cooker.

The aim of the present invention is the realization of a food preparation appliance that enables the voltage between the receiver coil and the induction coil to be kept constant.

The food preparation appliance realized in order to attain the aim of the present invention, explicated in the first claim and the respective claims thereof, is a food preparation appliance that is suitable to be operated on an induction heating cooker and comprises a body wherein foods are placed for performing operations like cutting, mixing and cooking, a cover that covers the body, and one or more than one receiver coil that is disposed on the base of the body and that cooperates with the induction coils on the induction heating cooker so as to enable the control unit to be energized.

The food preparation appliance of the present invention comprises a movement mechanism that enables the voltage between the receiver coil and the induction coil to be kept constant by changing the distance of the food preparation appliance to the cooker and a control unit that sends the command required for the movement mechanism to operate according to the voltage value.

In an embodiment of the present invention, the movement mechanism changes the distance between the receiver coil and the induction coil. Thus, the voltage between the coils is enabled to be within the proper voltage range.

In an embodiment of the present invention, the safe voltage range between the receiver coil and the induction coil is recorded in the memory of the control unit as between the values of Valt and Vüst.

In an embodiment of the present invention, the Valt value is defined as 50V.

In an embodiment of the present invention, the Vüst value is defined as 220V.

In an embodiment of the present invention, the movement mechanism is composed of a motor, a movement shaft moving downwards or upwards by rotating around itself with the movement received from the motor, feet and a motion transmitting means that provides the transfer of energy between the movement shaft and the feet. The movement mechanism is operated or stopped by the control unit.

In an embodiment of the present invention, the user can define the cooking time, cooking level and type of the food to be cooked on the control panel. Moreover, components such as mixer or chopper can be controlled via the control panel. According to the food type defined by the user, the control unit automatically determines the cooking time and activates the movement mechanism according to the cooking temperature.

In an embodiment of the present invention, the control unit monitors the distance between the receiver coil and the induction coil throughout the cooking process.

In an embodiment of the present invention, the control unit activates the movement mechanism at the end of the cooking time and moves the food preparation appliance away from the induction heating cooker. Thus, by interrupting the energy supplied there between, the control unit enables the food preparation appliance to end the cooking process.

In an embodiment of the present invention, the control unit activates the movement mechanism a short time before the end of the cooking process, thus enabling the body to be distanced from the cooker. Thus, the food in the body is prevented from burning.

In an embodiment of the present invention, when the cooking process is deactivated in the food preparation appliance, the speed of the mixing and chopping components is adjusted by operating the movement mechanism.

The food preparation appliance realized in order to attain the aim of the present invention is illustrated in the attached figures, where:

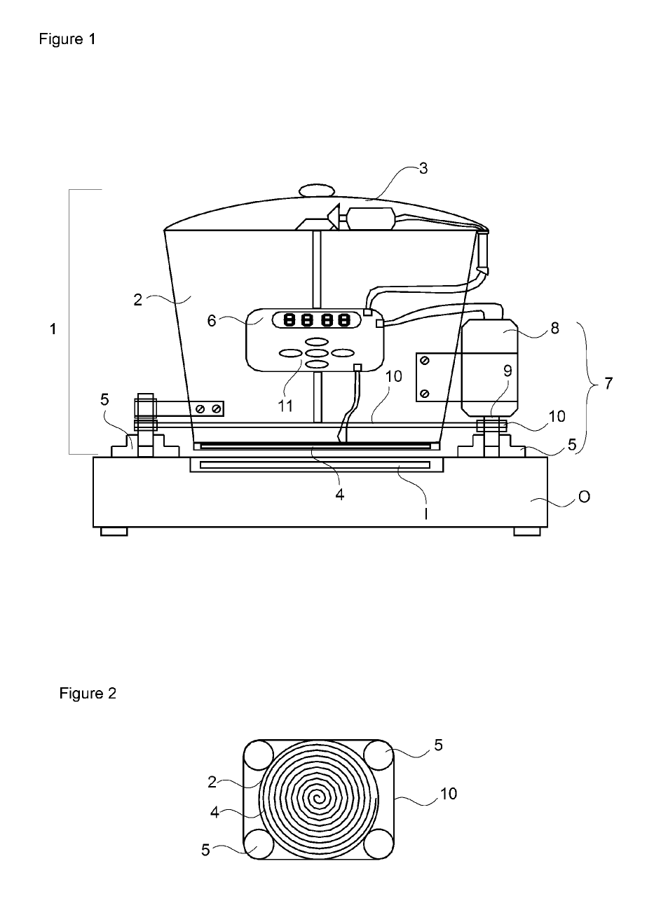

FIG. 1—is the schematic view of the food preparation appliance and the induction heating cooker.

FIG. 2—is the bottom view of the food preparation appliance.

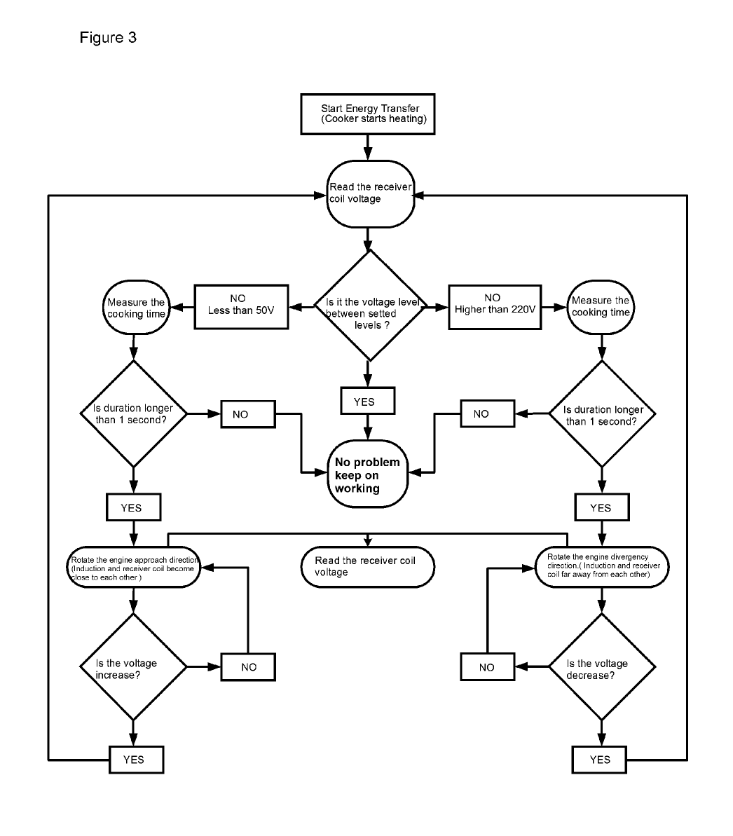

FIG. 3—is the operational algorithm of the food preparation appliance.

The elements illustrated in the figures are numbered as follows:

1. Food preparation appliance

2. Body

3. Cover

4. Receiver coil

5. Foot

6. Control unit

7. Movement mechanism

8. Motor

9. Movement shaft

10. Motion transmission means

11. Control panel

The food preparation appliance (1), suitable to be used on an induction heating cooker (O) with one or more than induction coil (I), comprises a body (2) wherein foods are placed for food preparation operations like cooking, cutting and mixing; a cover (3) mounted over the body (2); one or more than one receiver coil (4) that is disposed on the base of the body (2) and that receives energy from the coils (I) on the induction heating cooker (O); one or more than one foot disposed on the base of the body (2), and a control unit (6) that provides the controlling of parameters such as cooking temperature, cooking time, mixing speed, etc. By means of the receiver coil (4) integrated into the base of the body (2), energy is received from the induction coil (I) disposed on the induction heating cooker (O). Thus, by energizing the control unit (6), the food preparation appliance (1) carries out operations such as cooking, chopping, mixing, etc. and the electronic components can be controlled.

The food preparation appliance (1) of the present invention comprises a movement mechanism (7) that enables the distance between the receiver coil (4) and the induction coil (I) to be changed and further the control unit (6) that activates the movement mechanism (7) so as to keep the voltage value between the receiver coil (4) and the induction coil (I) within the safe values defined by the producer. Thus, the voltage value between the receiver coil (4) and the induction coil (I) is enabled to be kept constant and within the safe range according to the selected cooking level. While the movement mechanism (7) operates, the voltage value between the receiver coil (4) and the induction coil (I) is constantly measured. When the safe values are obtained, the movement mechanism (7) is stopped.

In an embodiment of the present invention, the food preparation appliance (1) comprises the movement mechanism (7) that enables the receiver coil (4) to get close to or away from the induction coil (I). Thus, the distance between the receiver coil (4) and the induction coil (I) can be changed.

In an embodiment of the present invention, a minimum voltage value Valt and a maximum voltage value Vüst, both defined by the producer, are recorded in the memory of the control unit (6). The voltage between the receiver coil (4) and the induction coil (I) is measured by the control unit (6). If the voltage value is not between Valt and Vüst, the movement mechanism (7) is activated by the control unit (6) and the distance between the receiver coil (4) and the induction coil (I) is adjusted.

In an embodiment of the present invention, the Valt value is defined as 50V. For voltage values below 50V, the movement mechanism (7) is activated by the control unit (6).

In an embodiment of the present invention, the Vüst value is defined as 220V. For voltage values above 220V, the movement mechanism (7) is activated by the control unit (6).

In an embodiment of the present invention, the movement mechanism (7) comprises a motor (8); a movement shaft (9) with one end connected to the motor (8) and the other end disposed on the foot (5), the movement shaft (9) rotating around itself with the motion received from the motor (8), the movement mechanism (7) further comprising a motion transmitting means (10) that delivers the rotational movement of the movement shaft (9) to other shafts on the body (2). Thus, the movement mechanism (7) enables the receiver coil (4) to get close to or away from the induction coil (I). If the voltage value between the receiver coil (4) and the induction coil (I) is not within the safe range of values, the control unit (6) activates the motor (8). The motor (8) converting the electric energy to kinetic energy enables the body (2) to descend/ascend by means of the movement shaft (9).

In an embodiment of the present invention, the food preparation appliance (1) comprises a control panel (11) that enables the user to define parameters such as cooking time, cooking temperature, food type, etc. and the control unit (6) that activates the movement mechanism (7) according to the food type defined by the user via the control panel (11) so as to determine the cooking time and the distance between the receiver coil (4) and the induction coil (I). The producer records the cooking times and levels according to the food types in the memory of the control unit (6). The user only selects the type of the food to be cooked via the control panel (11). The control unit (6) determines the cooking time and the distance between the receiver coil (4) and the cooker (O) according to the food type.

In an embodiment of the present invention, the control unit (6) monitors the distance between the body (2) and the cooker (O) during the cooking time and provides the adjustment of the distance therebetween. Thus, changes that may occur during the cooking time can be easily complied with.

In an embodiment of the present invention, when the cooking time ends, the control unit (6) enables the distance between the receiver coil (4) and the induction coil (I) to increase and interrupts the energy flow, thus provides the termination of the cooking process. Consequently, the foods are enabled to be cooked just as long as the defined time.

In an embodiment of the present invention, the control unit (6) activates the movement mechanism (7) a short time before the cooking time ends and enables the distance between the receiver coil (4) and the induction coil (I) to increase. The food is objected to a lower cooking temperature a short time before being completely cooked. Thus, the foods are prevented from burning.

In an embodiment of the present invention, when the cooking means is deactivated, the control unit (6) determines the speed of operations such as mixing, chopping, etc. by activating the movement mechanism (7). In cases of foods that should be mixed at a high speed or in cases of hard foods to be chopped, a higher amount of electric power is obtained by decreasing the distance between the receiver coil (4) and the induction coil (I).

By means of the present invention, a food preparation appliance (1) is realized, that is enabled to operate on the induction heating cooker (O) within safe voltage values. The movement mechanism (7) is operated by the control unit (6). With the activation of the movement mechanism (7), the distance between the receiver coil (4) and the induction coil (I) can be changed. Since the movement mechanism (7) disposed on the food preparation appliance (1) is mechanical, the movement mechanism (7) can be safely operated together with all types of induction heating cookers (O).

1. A food preparation appliance, suitable to be used on an induction heating cooker with one or more than induction coil, comprising
a body wherein foods are placed for food preparation operations like cooking, cutting and mixing,
a cover mounted over the body,
one or more than one receiver coil that is disposed on the base of the body and that receives energy from the coils on the induction heating cooker,
one or more than one foot disposed on the base of the body,
a control unit that provides the controlling of parameters such as cooking temperature, cooking time, mixing speed, etc.,
characterized by a movement mechanism that enables the distance between the receiver coil and the induction coil to be changed and further the control unit that activates the movement mechanism so as to keep the voltage value between the receiver coil and the induction coil within the safe values defined by the producer.

2. A food preparation appliance as in claim 1, characterized by the movement mechanism that enables the receiver coil to get close to or away from the induction coil.

3. A food preparation appliance as in claim 1, characterized by a minimum voltage value Valt and a maximum voltage value Vüst that are defined by the producer in the memory of the control unit.

4. A food preparation appliance as in claim 3, characterized by the control unit wherein the Valt value is 50V.

5. A food preparation appliance as in claim 3, characterized by the control unit wherein the Vüst value is 220V.

6. A food preparation appliance as in claim 1, characterized by the movement mechanism comprising a motor; a movement shaft with one end connected to the motor and the other end disposed on the foot, the movement shaft rotating around itself with the motion received from the motor, the movement mechanism further comprising a motion transmitting means that delivers the rotational movement of the movement shaft to other shafts on the body.

7. A food preparation appliance as in claim 1, characterized by a control panel that enables the user to define parameters such as cooking time, cooking temperature, food type, etc. and the control unit that activates the movement mechanism according to the food type defined by the user via the control panel so as to determine the cooking time and the distance between the receiver coil and the induction coil.

8. A food preparation appliance as in claim 1, characterized by the control unit that monitors the distance between the body and the cooker during the cooking time and provides the adjustment of the distance there between.

9. A food preparation appliance as in claim 1, characterized by the control unit that, when the cooking time ends, enables the distance between the receiver coil and the induction coil to increase and interrupts the energy flow, thus provides the termination of the cooking process.

10. A food preparation appliance as in claim 1, characterized by the control unit that activates the movement mechanism a short time before the cooking time ends and enables the distance between the receiver coil and the induction coil to increase.

11. A food preparation appliance as in claim 1, characterized by the control unit that, when the cooking process is deactivated, determines the speed of operations such as mixing, chopping, etc. by activating the movement mechanism.
